(19) United States
(12) Patent Application Publication
(10) Pub. No.: US 2013/0333581 A1
(43) Pub. Date: Dec. 19, 2013

(54) PAD PRINGTING MACHINE

(71) Applicant: ITW Morlock GmbH, (US)

(72) Inventor: Udo VOGT, Rottenburg (DE)

(73) Assignee: ITW Morlock GmbH, Dornstetten (DE)

(21) Appl. No.: 13/866,485

(22) Filed: Apr. 19, 2013

Related U.S. Application Data
(63) Continuation of application No. 12/933,985, filed on Sep. 22, 2010, now abandoned.

(30) Foreign Application Priority Data
May 8, 2008 (DE) 10 2008 022 876.1

(51) Int. Cl. B41F 17/00

(52) U.S. Cl. CPC B41F 17/001
USPC 101/287

(57) ABSTRACT

A pad printing machine comprising at least one inverted planetary roller threaded drive (12; 24; 36; 48; 60; 62) and application of latter to a pad printing machine.

The present invention relates to a pad printing machine defined in the preamble of claim 1.

The present invention furthermore relates to using an inverted planetary roller threaded drive to displace and position at least one displaceable sub-assembly of a pad printing machine.

Pad printing machines are known for instance from the patent documents EP 1 636 031 B1 and DE 10 2005 060 550 A1.

Electrically adjusting cylinders fitted with a planetary roller threaded drive are known for instance from the patent document EP 0 671 070 B1 (=DE 694 16 818 T2).

The objective of the present invention is to solve the problem of more accurately controlling the pad printing machine.

The invention solves this problem by the features of the independent claims. Preferred embodiment modes are defined in the dependent claims.

Accordingly the present invention concerns a pad printing machine comprising at least one displaceable sub-assembly configured displaceably relative to at least one second sub-assembly, further an electric, adjusting linear-actuator which is mechanically connected to the minimum of one displaceable first sub-assembly to drive it, characterized in that the electric, adjusting linear-actuator is fitted with an inverted planetary roller threaded drive.

Furthermore the present invention relates to the application of at least one linear adjusting actuator fitted with an inverted planetary roller threaded drive to move at least one displaceable first sub-assembly relative to at least one second sub-assembly of a pad printing machine.

The displaceable first sub-assembly illustratively my be a printing plate support, an ink cup support, a pad support, an object support holding an object to be/being printed, and/or a displaceable printing-unit carrier for one or two or more pad printing units.

The electric, adjusting linear-actuator (electric adjusting cylinder) containing the inverted planetary roller threaded drive offers the advantage over compressed air controls that the speeds and positions of displaceable components of the pad printing machine can be controlled accurately. Accurate time-dependent and/or path-dependent compressive forces may be set and holding durations for displaceable components can be defined. Moreover they may exert large forces while being very compact.

A control system driving the inverted planetary roller threaded drive may be hard programmed or preferably be optionally programmable. Also ink withdrawals and ink depositions may be programmed.

The present invention allows substantially improving, a least in part, printing quality.

The electric, adjusting linear-actuator (electric adjusting cylinder) of the present invention fitted with the inverted planetary roller threaded drive may replace totally pneumatic or hydraulic actuators heretofore required to attain similarly high forces in pad printing machines, however without incurring the drawbacks regarding maintenance or possible leakages of pneumatic or hydraulic actuators. Ordinarily hydraulic actuators may not be used with pad printing machines because of the danger of leakage. On the other hand the novel actuator of the present invention is applicable even to the so-called clean rooms.

Planetary roller threaded drives and their controls are known for instance from the patent document EP 0 671 070 B1 (=DE 694 16 818 T2).

The present invention is elucidated below in relation to the appended drawings of preferred illustrative embodiment modes.

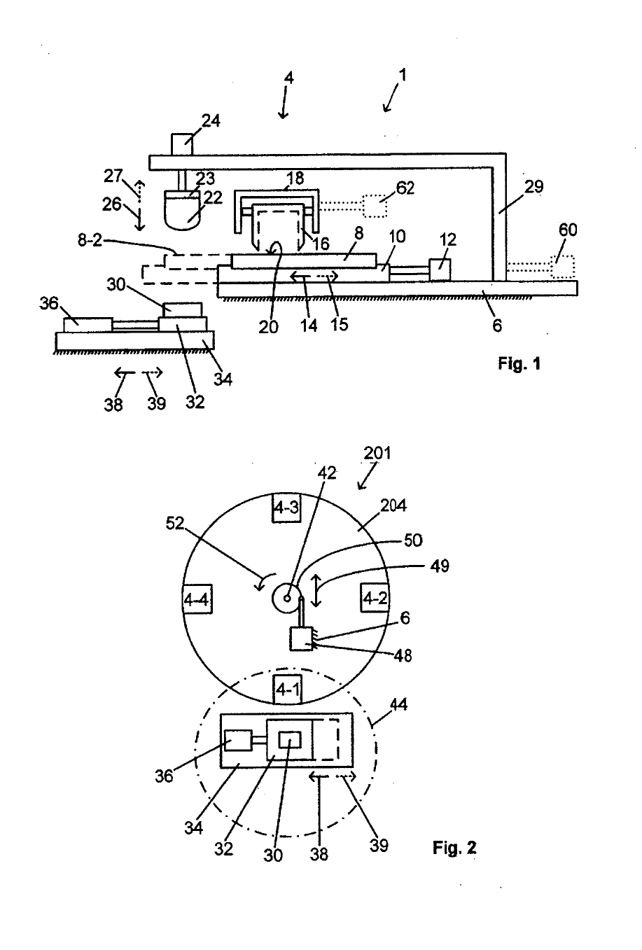

FIG. 1 is a schematic side view of a printing unit and an object carrier of a pad printing machine of the invention,

FIG. 2 is a schematic top view of a pad printing machine of several printing units,

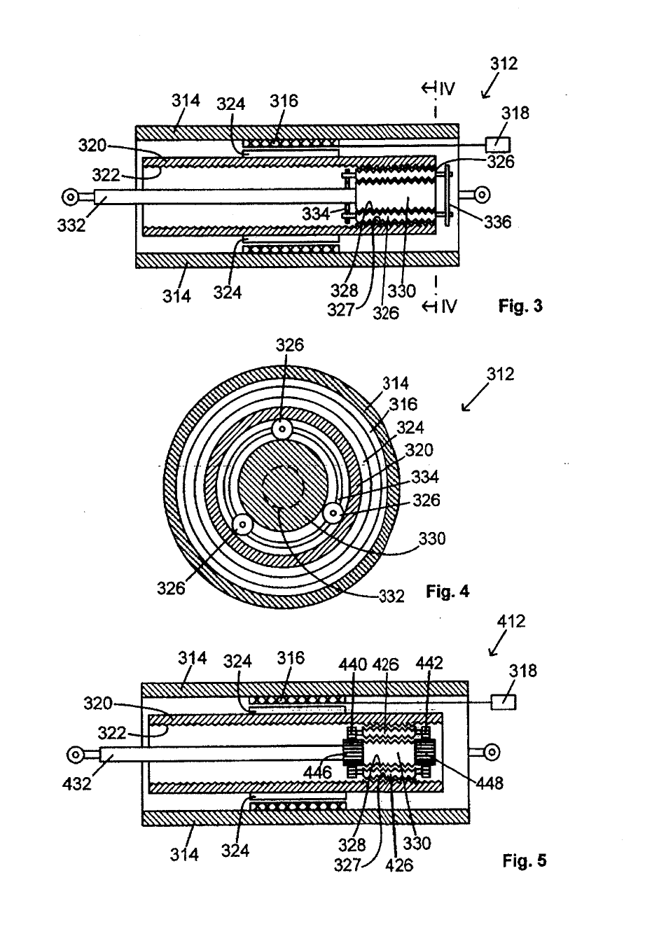

FIG. 3 is a schematic longitudinal section of an electric linear actuator (electrical adjusting cylinder) fitted with an inverted planetary roller threaded drive used in a pad printing machine of the invention,

FIG. 4 schematically shows a cross-section in the plane IV-IV of FIG. 3, and

FIG. 5 is a schematic longitudinal section of a further embodiment mode of an electrical, adjusting linear-actuator (electrical adjusting cylinder) fitted with inverted planetary roller threaded drive to be used in a pad printing machine of the present invention.

The pad printing machine schematically shown in FIG. 1 contains a printing unit 4. This printing unit 4 contains a printing-unit support 6 which directly rests on a printing plate 8 or, as shown in FIG. 1, rests on a printing plate base 10, and which is reciprocated according to arrows 14 and 15 by an electric, adjusting linear-actuator 12 between the ink receiving position indicated in FIG. 1 by a solid line and an ink transfer position as indicated in said Figure by dashed lines. In FIG. 1 the adjusting linear-actuator 12 is configured between the printing plate support 10 and the printing unit 6 and may displace the former relative to the latter.

An ink cup 16 is situated on the printing plate 8 and is kept stationary in a predetermined position by an ink cup support 18 and is shown in the ink receiving position of the printing plate 8 above at least one recess 20 in said plate 8, whereby ink contained in the ink cup 16 can enter the recess(es) 20. The minimum of one recess 20 is in the shape of the printed image (image or text) as yet to be printed.

The ink cup 16 remains in the position shown in FIG. 1 even when the printing plate 8 is moved from the position shown in solid lines into forward into the ink transfer position wherein the printing plate 8 is denoted by the reference 8-2. When the printing plate 18 is in the ink transfer position where it is denoted by 8-2, a pad 22 can be lowered by means of a second electric, adjusting linear-actuator 24 (electric adjusting cylinder) from the upper initial position shown in FIG. 1 in the direction shown by an arrow 26 onto the recess(es) 20 of the printing plate 8, in order to absorb the printing ink therein. Next the pad 22 is moved upward as shown by an arrow 27 by means of the electric, adjusting linear-actuator 24. Then the printing plate 8 can be returned into its ink-receiving position shown by solid lines in FIG. 1 by means of the first electric, adjusting linear-actuator 12.

The second electric, adjusting linear-actuator 24 is mechanically connected on one hand to a pad support 23 of the pad 22 and on the other hand by a pad support 29 to the printing unit 6.

Thereupon the pad 22 can be by means of the second electric, adjusting linear-actuator 24 again as indicated by the same vertical arrows 26 respectively 27 down onto an object to be printed 30 and then back up in order to transfer the ink to the object being printed 30.

The object to be/being printed 30 is situated on an object carrier 32. This object carrier 32 may be configured to be stationary or be displaceable on an object base 34 by means of a third electric, adjusting linear-actuator 36 (electrical adjusting cylinder) between the printing position shown in FIG. 1 and an object deposition position away from said object printing position, for instance as indicated by the respective arrows 38 and 39.

The further embodiment mode of a pad printing machine of the present invention shown in FIG. 2 contains several, for instance four printing units 4-1, 4-2, 4-3 and 4-4 which are mounted on a printing unit carrier 204 rotatable about a vertical axis of rotation 42, each of said printing units 4-1 through 4-4 corresponding to a printing unit 4 of FIG. 1. These printing units 4-1 through 4-4 rotate jointly with the printing carrier 204 sequentially past a printing station 44 where an object 30 is printed. As shown in FIG. 1, the object to be/being printed 30 again may be located on the object carrier 32. Said object carrier can be mounted on an object base 14. The object carrier 32 may be displaced by a third electric, adjusting linear-actuator 36 (electric adjusting cylinder) as indicated by the arrows 38 respectively 39.

The printing unit carrier 204 of FIG. 2 may be rotated for instance by an electric or pneumatic actuator, in particular a rotational actuator, or by a fourth electric, adjusting linear-actuator 48 of which the linear displacement is converted as indicated by double arrow 49 by means of an idler mechanism 50 into a rotational displacement of the printing unit carrier 204, for instance clockwise as indicated by an arrow 52.

Identical/corresponding components shown in FIGS. 1 and 2 are denoted by the same references below. There are variations: the printing unit carrier 6 and the object base 34 (or object carrier 32) of FIG. 1 may be separate components or they may be a single component. A fifth electric, adjusting linear-actuator 60 (electrical adjusting cylinder) may be used to horizontally displace the printing plate carrier 10 and/or a sixth electric, adjusting linear-actuator 62 may serve to position the ink cup 16 on the printing plate 8. The fifth and sixth linear adjusting actuators 60 respectively 62 are represented by dotted lines. The terminology of “first, second, third, fourth, fifth and sixth electric, adjusting linear-actuator” does not define a definite number nor a definite sequence of the electric, adjusting linear-actuators, instead it serves only to describe them individually and to distinguish between them.

At least one of electric, adjusting linear-actuators (electric adjusting cylinder) 12, 24, 36, 48, 60 and/or 62 contains an inverted planetary roller threaded drive and preferably also a computerized control associated with said drive which preferably is programmed/programmable to match predetermined pad printing procedures. Possible embodiment modes of such electric, adjusting linear-actuators fitted with a planetary roller threaded drive and with a corresponding control illustratively are known from the EP 0 671 070 B1 patent document and are briefly discussed below.

The electric, adjusting linear-actuator 312 schematically shown in FIGS. 3 and 4 comprises an external pipe 314 fitted with an electric motor winding 316 on its inside so that said pipe and winding together constitute an electric motor stator 314/316. The motor winding 316 is driven by an electric control 318 and fed by it with electric power. The external pipe 314 comprises radially inside the motor winding 316 an inner pipe 320 that is fitted with an internal thread 322 and with permanent magnets 324 at its outside. Together with its permanent magnet 324, the inner pipe 320 constitutes the electric motor's rotor 320/324.

Several planetary rollers 326—which are fitted with an outer thread 327 matching the inner thread 322 of the inner pipe 320—are distributed around the inner circumference of the inner pipe 320 and engage the inner thread 322 of the inner pipe 320. The outer thread 327 of the planetary rollers 326 also engages the external, circumferential grooves 328 of a drive segment 330 fashioned at one end of a drive spindle 332. The drive segment 330 is part of the drive spindle 332 or irrotationally joined to it. The drive spindle 332 may be solid or tubular.

The outer circumferential grooves 328 of the drive segment 330 may consist of a threaded groove or of individual annular grooves.

The planetary rollers 326 may be kept apart from each other for instance by rings 334 and 336

When rotating the rotor 320/324 constituted by the inner pipe 320 and the permanent magnets 324, the planetary rollers 326 are axially moved relative to the said pipe 320 in its inside thread 322. In the process the planetary rollers 326 axially entrain the drive segment 330 and the drive spindle 332 connected to or integral with said drive segment, as a result of which the said drive spindle is axially displaced relative to the inside pipe 320 and hence also relative to the outer pipe 314.

The further electrical, adjusting linear-actuator 412 shown in FIG. 5 is similar to the linear adjusting actuator 312 of FIGS. 3 and 4, except that the circumferential spacings of the planetary rollers 428 are not kept apart by rings 334 and 336 but by gears 440 and 442 or toothed rings which are constituted on or affixed to the ends of the planetary rollers 426, and which mesh by their teeth with those of the gearing rings 446 respectively 448 that are constituted at or affixed to the drive spindle 432 on each side of its drive segment 330. The same reference numerals apply in FIG. 5 as they do in FIGS. 3 and 4 where the components are the same. Being functionally identical, they are not described again with respect to FIG. 5.

1. Pad printing machine comprising at least one first sub-assembly configured displaceably relative to at least one second sub-assembly; further an electrical, adjusting linear-actuator that is mechanically connected with said first displaceable sub-assembly in order to move the minimum of one displaceable first sub-assembly relative to the second sub-assembly wherein
the electrical, adjusting linear-actuator is fitted with an inverted planetary roller threaded drive.

2. Pad printing machine as claimed in claim 1, characterized in that the minimum of one displaceable first sub-assembly is at least one of the following components: a printing plate, a printing plate support, a pad support, an object carrier carrying an object to be/being printed, a displaceable printing unit carrier carrying a pad printing unit or at least two pad printing units, a pad carrier and/or an ink cup support.

3. Pad printing machine as claimed in claim 1, wherein a programmed or programmable control is connected to the linear adjusting actuator to control it.

4. Application of an electric, adjusting linear-actuator comprising an inverted planetary roller threaded drive to displace and position at least one displaceable first sub-assembly relative to at least one second sub-assembly of a pad printing machine.

5. Application as claimed in claim 4, wherein minimum of one first sub-assembly comprises at least one of the following components: a printing plate, a printing plate support, a pad support, an object carrier bearing an object to be/being printed, a displaceable printing unit carrying a pad printing unit or at least two pad printing units, a pad carrier and/or an ink cup support.

6. Pad printing machine as claimed in claim 1, further comprising an ink cup and a print plate, wherein the machine is configured to move the print plate relative to the ink cup via actuation of the electrical, adjusting linear-actuator.
